(19) United States
(12) Patent Application Publication
(10) Pub. No.: US 2020/0302360 A1
(43) Pub. Date: Sep. 24, 2020

(54) SYSTEM AND METHOD FOR ENTERPRISE RESOURCE MANAGEMENT

(71) Applicant: ServiceNow, Inc., Santa Clara, CA (US)

(72) Inventors: Anna Kotliarevskaia, San Diego, CA (US); Pradeep Bansal, Foster City, CA (US); Colin Jayes O'Brien, Marietta, GA (US); Sharath Chandra Lagisetty, Hyderabad (IN)

(21) Appl. No.: 16/357,782

(22) Filed: Mar. 19, 2019

(51) Int. Cl. G06Q 10/06

(52) U.S. Cl. CPC G06Q 10/06315

(57) ABSTRACT

A resource allocation interface implemented by a computing system may be implemented on a client instance. The resource allocation interface determines an identity of an entity within an overall multi-layer resource allocation hierarchy. The resource allocation interface may then present resource allocation data on the resource allocation interface commensurate with the identity of the user or the layer of the hierarchy with which the user is associated. The resource allocation interface may receive user inputs to portions of the resource allocation data. In response to receiving user inputs to the portions of the resource allocation data the user has permission to access, the resource allocation interface implements the user customizations based on those user inputs. In this manner, the user may create a new project, request funds for a project, allocate funds, approve requests for funds, customize existing resource allocation plans, and so forth, all within the resource allocation interface.

### BACKGROUND

The present disclosure relates generally to managing the allocation of enterprise resources.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Certain job functions, such as allocating resources (e.g., fiscal resources, labor, time, etc.) are important to the growth of many organizations, including those using a cloud-based platform. Users tasked with efficiently managing the allocation of resources and/or other organization-related functions (e.g., allocating resources to promote the growth of the organization) may be required to engage with an ever increasing number of computer applications to properly and efficiently perform their job functions. Indeed, various functions targeted at promoting growth within the various organizations of the enterprise (such as for requesting resources to various projects of the enterprise, approving resource allocation requests, viewing resource allocation historical data associated with the enterprise, and the like), are typically implemented via separate interfaces or distinct applications. As a result, executing functions associated with the allocation of resources may require a user to juggle the task of navigating between various distinct applications, which reduces productivity, efficiency, and the ease of competing such resource allocation tasks.

### SUMMARY

A summary of certain embodiments disclosed herein is set forth below. It should be understood that these aspects are presented merely to provide the reader with a brief summary of certain embodiments and that these aspects are not intended to limit the scope of this disclosure. Indeed, this disclosure may encompass a variety of aspects that may not be set forth below.

Present embodiments are directed toward systems and methods for enhancing the organization and overall management of resource allocation items by synchronizing various resource management functionalities into a unified interface. For instance, present embodiments include providing users with a variety of functionalities and tools for managing resources within an enterprise based on an identity of the user and/or a position (e.g., layer) occupied by the user within a multi-layer resource allocation hierarchy of an enterprise. To that end, present embodiments include determining an identity of the user and then presenting resource allocation data commensurate with the identity of the user and/or commensurate with the layer within the hierarchy that the user occupies. In turn, present embodiments include allowing user access to portions of the resource allocation data based on the identity of the user or position (e.g., layer) occupied by the user within a multi-layer resource allocation hierarchy of an enterprise. In response to receiving user inputs to the portions of the resource allocation data the user has permission to access, present embodiments include implementing and incorporating the user customizations based on those user inputs. In this manner, the user may create a new resource allocation item, request funds for a resource allocation item, allocate funds for resource allocation item, approve requests for funds, and customize existing resource allocation item, to name a few resource allocation functionalities.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud computing system, in accordance with aspects of the present approach;

FIG. 2 is a block diagram of an embodiment of a multi-instance cloud architecture, in accordance with aspects of the present approach;

FIG. 3 is a block diagram of a computing device utilized in a computing system that may be present in FIG. 1 or 2, in accordance with aspects of the present approach;

FIG. 4 is an embodiment of a virtual server that supports and enables a client instance to access a variety of resource allocation items, in accordance with aspects of the present approach;

FIG. 5 is a flow diagram of a multi-layer resource allocation hierarchy, illustrating an embodiment of allocation of resources within an enterprise, in accordance with aspects of the present approach;

FIG. 6 is an embodiment of a portal of the resource allocation interface having a list of resource allocation items associated with a user, in accordance with aspects of the present approach;

FIG. 7 is an embodiment of an allocation detail view for a selected resource allocation from the list of resource allocation items of FIG. 6, in accordance with aspects of the present approach;

FIG. 8 is an embodiment of a pop-up window for adding new resource allocation items to the list of resource allocation items of FIG. 6, in accordance with aspects of the present approach;

FIG. 9 is an embodiment of the allocation detail view of FIG. 7 including the previously funded resource allocation items added from the pop-up window of FIG. 8, in accordance with aspects of the present approach;

FIG. 10 is an embodiment of the detail view of FIG. 7 including the existing resource allocation items added from the pop-up window of FIG. 8 and the newly created resource allocation item, in accordance with aspects of the present approach;

FIG. 11 is a tree representation of the resource allocation items, in accordance with aspects of the present approach;

FIG. 12 is an embodiment of a graphical representation of an allocation budget versus the actual budget of the resource allocation interface of FIG. 6, in accordance with aspects of the present approach;

FIG. 13 is an embodiment of a goals detail view of goals associated with a resource allocation, in accordance with aspects of the present approach;

FIG. 14 is an embodiment of a historical data view of historical data associated with a resource allocation item, in accordance with aspects of the present approach;

FIG. 15 is an embodiment of using a copy option to propagate fields of a resource allocation item with information copied from previously funded resource allocations, in accordance with aspects of the present approach;

FIG. 16 is an embodiment of allocation detail view of FIG. 7, illustrating a resource allocation item that includes a request for resources, in accordance with aspects of the present approach;

FIG. 17 is an embodiment of a requests view in which the resource allocation interface presents requests for approval, in accordance with aspects of the present approach;

FIG. 18 is an additional embodiment of a requests view in which the resource allocation interface presents requests for approval, in accordance with aspects of the present approach; and

FIG. 19 is a flow diagram of an embodiment of a process for facilitating the management of resource allocations, in accordance with aspects of the present approach.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to a single electronic computing device that includes, but is not limited to a single computer, virtual machine, virtual container, host, server, laptop, and/or mobile device, or to a plurality of electronic computing devices working together to perform the function described as being performed on or by the computing system. As used herein, the term “medium” refers to one or more non-transitory physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “resource allocation item” refers to an object used to identify a certain resource allocation within the multi-layer resource allocation hierarchy of the enterprise. The resource allocation items may be presented on the resource allocation interface disclosed herein. In some embodiments, the “resource allocation item” may be any task or project requiring resources for completion. For example, the resource allocation item may include a set of projects arranged in the multilayer resource allocation hierarchy, an enterprise project (e.g., building a new building, hiring additional staff, and so forth), an enterprise task, an enterprise entity (e.g., a new department, unit, or organization), a portfolio, a vice president (VP), a strategic object, a team, an Idea, an Epic, or an enterprise project, or any combination thereof. Access to these “resource allocation items” may be restricted to those users satisfying a permission requirement, as discussed in detail below.

As used herein, the term “multi-layer resource allocation hierarchy” refers to a plurality of layers by which an enterprise may be organized around, such that each of the layers includes people (e.g., a VP), organizations, portfolios, strategic objects, teams, Ideas, Epics, projects, or any other entity associated with the enterprise. Furthermore, each layer in the “multi-layer resource allocation hierarchy” may be associated with certain permissions. In addition, each entity (e.g., person, organization, project, etc.) in the layer may be assigned more or less permission(s) than those associated with the layer by default. In this manner, each layer of the multi-layer resource allocation hierarchy may be associated with certain permissions, and those permissions may be modified to include more or less permissions by an entity (e.g., person, organization, project, etc.) within that layer, having permission to do so.

With these terms in mind, users, enterprises, and/or other organizations may utilize a computer-based system, such as a computer-based system employing a cloud-based infrastructure, to conduct activities or otherwise run an organization as discussed herein. Additionally, users may form a part of the organization and may each be in charge of managing certain tasks related to the operation of the organization of promoting the growth of the organization. In the context of managing resources, for example, a multi-layer architecture of entities may include a first layer that includes enterprise projects and associated users, such that those entities in the first layer may execute only one resource management function, such as requesting resources. Continuing this example, the multi-layer resource allocation hierarchy may include a second layer that includes project managers responsible for receiving resources from the third layer and allocating those received resources to the projects in the first layer. As such, the second layer may be assigned permissions, such as receiving (from the third layer) resources and allocating resources (to the first layer). In some contexts, additional permission layers may be assigned to the multi-layer resource allocation hierarchy. These resource allocations may be presented on the disclosed resource allocation interface as corresponding resource allocation items.

Integrating and coordinating the overall management of resource allocation may be an important feature associated with promoting the growth or facilitating operation of the enterprise. Of course, separate enterprises may be organizing using different multi-layer hierarchies. For example, a larger enterprise may have more layers and more entities per layer, making their multi-layer resource allocation hierarchy complex. Present embodiments allow for user configuration (i.e., customization) of a multi-layer resource allocation hierarchy, for example, by allowing addition or reduction of layers to the multi-layer resource allocation hierarchy, allowing addition or reduction of entities in the layers, allowing access to historical resource allocation data, and allowing modifications based on the layer permissions associated with individuals in the layers (i.e., the permissions assigned to a group of common individuals) and the individual permissions associated with the entities in those layers, among other customization features. Indeed, the embodiments disclosed herein may be flexible so as to allow for additional or less hierarchies instead of requiring a rigid structure.

Present embodiments are directed toward a system for enhancing the organization and overall management of resource allocation items by way of an identity of an entity within an overall multi-layer resource allocation hierarchy. For example, the computing system may determine the identity or characteristics of the entity, such as the role of a user. The computing system may then present resource allocation data on the disclosed resource allocation interface commensurate with the identity or characteristics of the user or the layer of the hierarchy with which the user is associated. The computing system may allow user access to the portions of the resource allocation data based on the identity of the user or the layer of the hierarchy with which the user is associated. In response to receiving user inputs to the portions of the resource allocation data the user has permission to access, the computing system implements the user customizations based on those user inputs. In this manner, the user may create a new project, request funds for a project, allocate funds, approve requests for funds, customize existing resource allocation plans, and so forth.

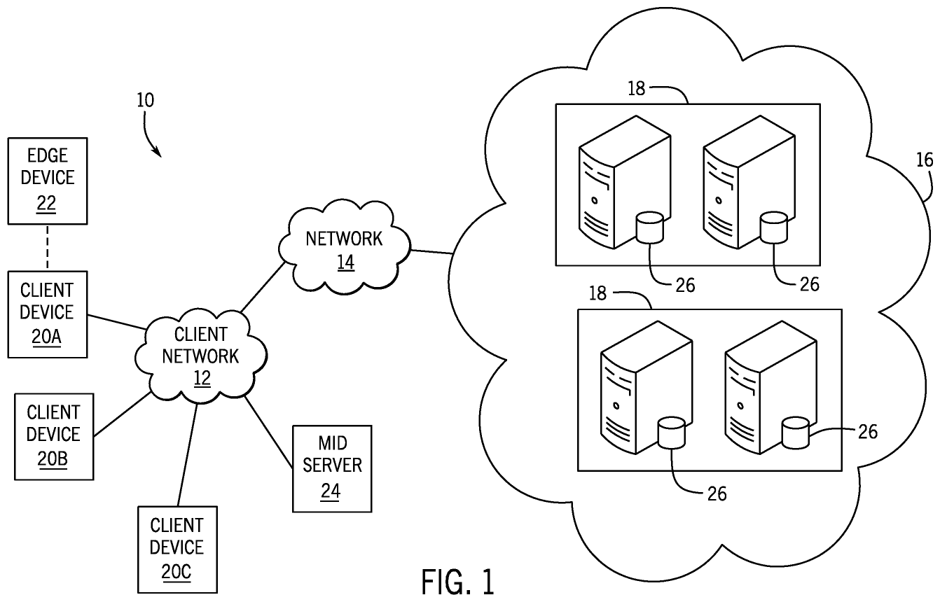

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

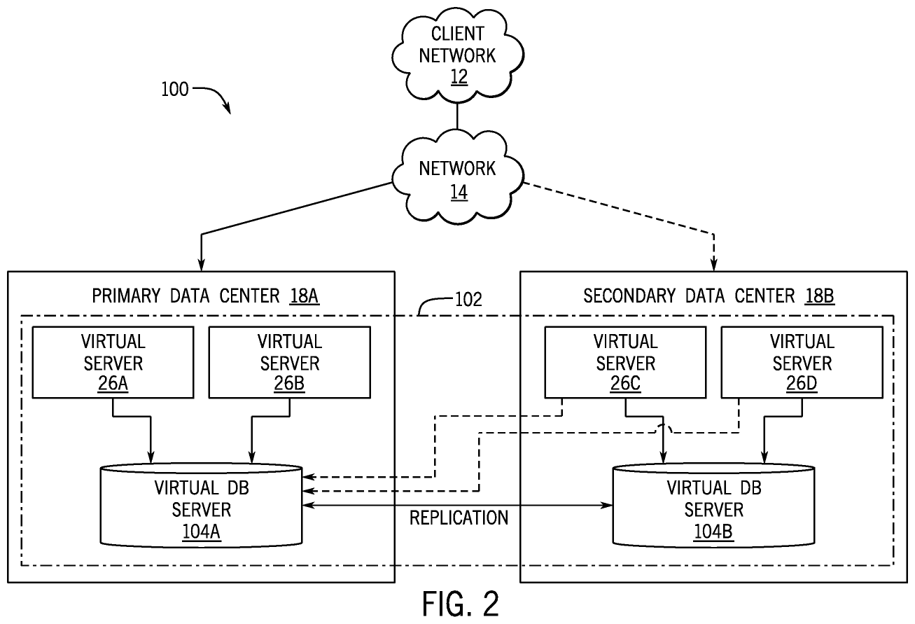

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion. For example, a computing system having access to the network 14 and primary and secondary data centers 18A, 18B may be able to access and customize certain resource allocation data based on an identity of the entity (e.g., user) associated with the computing system and/or based on the layer of the multi-layer resource allocation hierarchy to which the user is assigned.

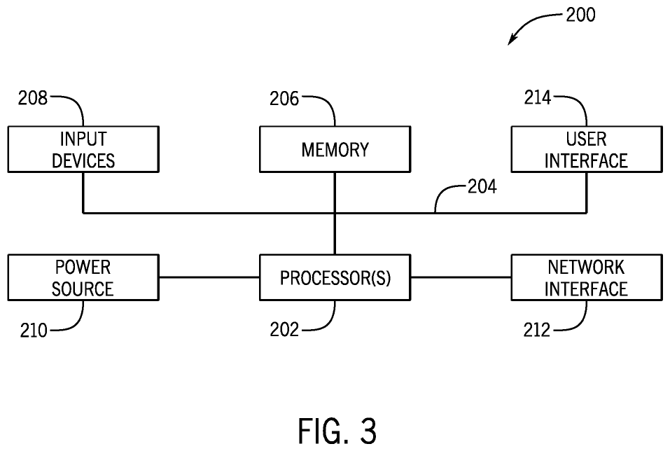

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

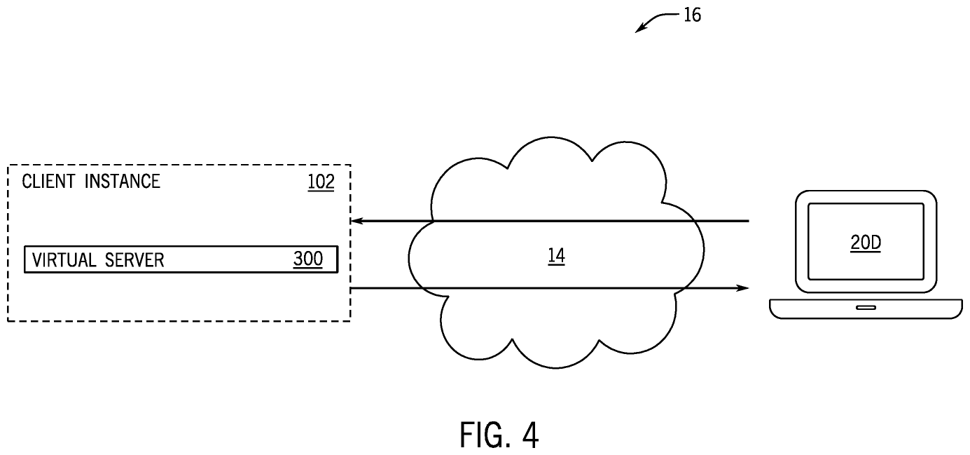

In some contexts, the embodiments disclosed herein may be employed on a client instance to coordinate and facilitate the allocation of resources by way of the disclosed resource allocation interface. With the preceding in mind, FIG. 4 is a block diagram illustrating an embodiment in which a virtual server 300 supports and enables the client instance 102 to access a variety of resource allocation applications or routines 302 (which may be executed using application servers and/or database servers implemented as part of the client instance 102), according to one or more disclosed embodiments. More specifically, FIG. 4 illustrates an example of a portion of a service provider cloud infrastructure, including the cloud-based platform 16 discussed above. The cloud-based platform 16 is connected to a client device 20D via the network 14 to provide a user interface to network applications (e.g., resource allocation applications) executing within the client instance 102 (e.g., via a web browser of the client device 20D). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

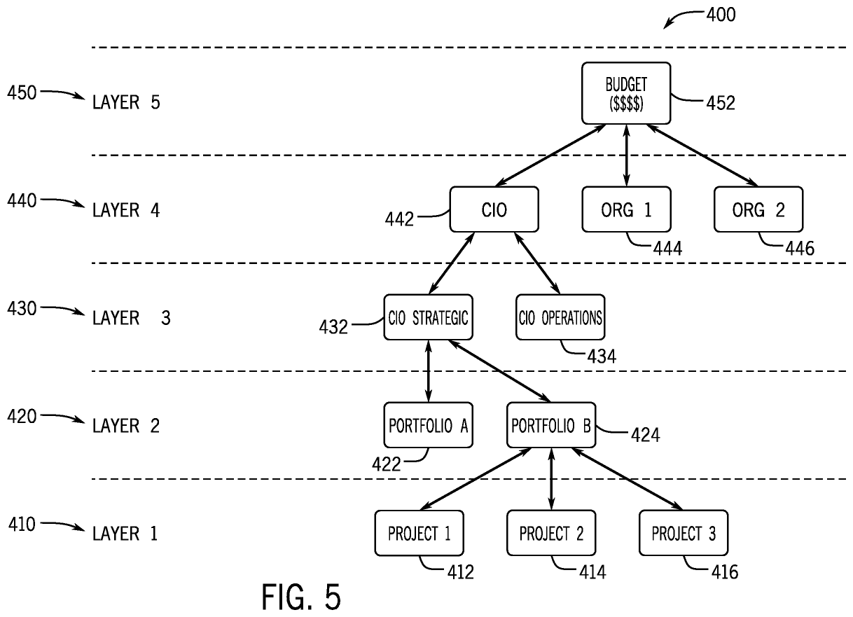

FIG. 5 is a flow diagram of a multi-layer resource allocation hierarchy 400, illustrating an embodiment of a flow and allocation of resources within an enterprise, in accordance with aspects of the present approach. The allocation of resources by entities may be realized by a top-down approach (e.g., resources are allocated from a budget down to various projects via the layers and entities discussed below), a bottom-up approach (e.g., resources are requested by various entities), or a combination thereof. The allocation of resources within the resource allocation interface may be represented by resource allocation items.

To help illustrate, the multi-layer resource allocation hierarchy 400 includes a first layer 410 associated with a three entities, namely, a first project 412, a second project 414, and a third project 416. The multi-layer resource allocation hierarchy 400 includes a second layer 420 associated with two entities, namely, a first portfolio 422 and a second portfolio 424. The multi-layer resource allocation hierarchy 400 includes a third layer 430 associated with two entities, namely, a Chief Information Officer's (CIO's) strategic portfolio 432 and the CIO's operations portfolio 434. The multi-layer resource allocation hierarchy 400 includes a fourth layer 440 associated with three entities, namely, the CIO 442, a first organization 444, and a second organization 446. The multi-layer resource allocation hierarchy 400 includes a fifth layer 450 associated with one entity, namely, the entire enterprise budget 452.

Using a bottom-up approach for resource allocation, an entity in the first layer 410 may request resources, such that entities is the second layer 420 (or any of the higher layers [e.g., third, fourth, fifth layers 430, 440, 450]) may need to approve of the request for the first layer 410 may receive those requested resources. For example, the first project 412 may request resources from the second portfolio 424, such that the resources are allocated to the first project 412 after the second portfolio 424 approves of the resource allocation request.

Using a top-down approach, the second portfolio 424 may receive resources from the CIO strategic portfolio 432. For example, the second portfolio may allocate resources to the first project 412, the second project 414, and the third project 416 in accordance to a strategic resource allocation scheme with or without a request of resources from the first layer 410. As mentioned above, the embodiments disclosed herein may be employed by enterprises using a top-down approach, a bottom-up approach, or any combination thereof, for managing resource allocations.

It should be appreciated that the multi-layer resource allocation hierarchy 400 may include any number of layers with any number of entities associated with the layer. For example, while in the illustrated approach, the fifth layer 450 is the top layer and is only associated with one entity, namely the total enterprise budget 452, in another embodiment, the fifth layer 450 may include any additional or alternative entities. Further, in some contexts, the entities may include users, organizations, or a group of users, or any combination thereof.

Furthermore, in some contexts, the higher layers may include group permissions inclusive to those permissions of the lower layers. For example, the entities in the fifth layer 450 may include group permissions that include all permissions associated with the second layer 420 because the fifth layer 450 is higher than the second layer 420. Similarly, lower layers may be restricted regarding their permissions. For example, while the first layer 410 may only request resources, the second layer 420 may approve requests for resources (e.g., from the first layer 410) and also request resources from higher layers. That is, entities in first layer 410 may be restricted from performing certain resource allocation functions permissive to the entities in the second layer 420.

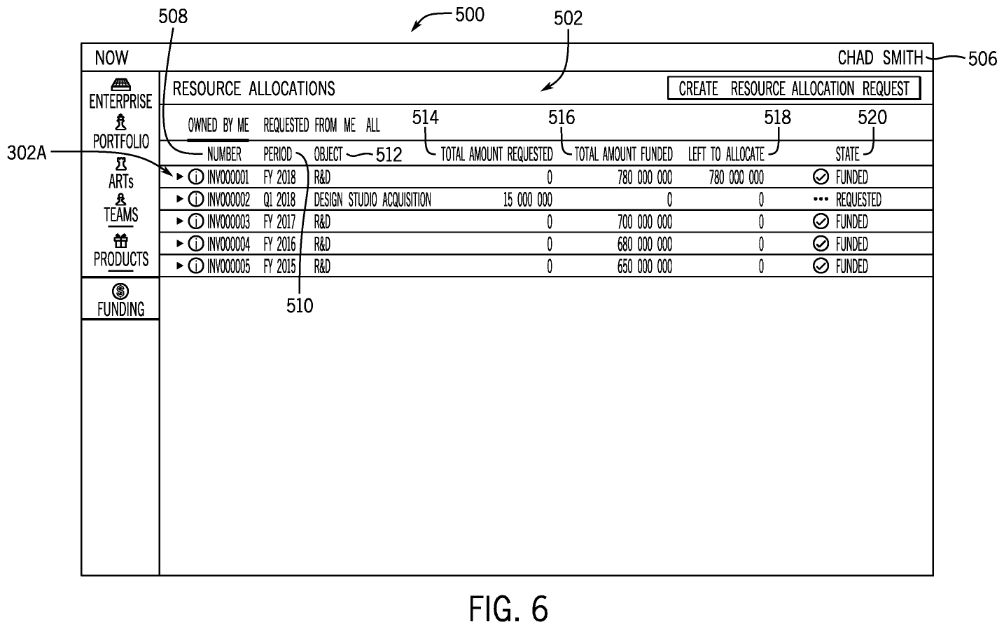

FIG. 6 is an embodiment of a funding portal 502 of a resource allocation interface 500 having a list of resource allocation items 302 associated with a user 506, in accordance with aspects of the present approach. The resource allocation items 302 may represent actual resource allocations within the enterprise. As illustrated, the user 506 (in this example, Chad Smith) is associated with five resource allocation items 302 presented as a list. Each of the five resource allocation items 302 includes an identification number 508, a period 510 for which the resource allocation item 302 is/was funded, an object 512 indicative of a description of the resource allocation item 302, an amount request 514, an amount funded 516, and amount left to allocate 518, and a funding state 520.

In this example and as illustrated, the first resource allocation item 302A includes an identification number 508 “INV000001.” The first resource allocation item 302A includes “FY 2018” as the period 510 and “Funded” as the funding state 520 to indicate that the first resource allocation item 302A was funded for the fiscal year in 2018. Furthermore, the first resource allocation item 302A includes “R&D” as the object 512, includes “0” as the amount requested 514, includes “780,000,000” as the amount funded 516, and “780,000,000” as the amount left to allocate 518 to indicate that the first resource allocation item 302A is a research and development (R&D) project that was funded for the 2018 fiscal year for $780,000,000. In particular, as indicated by the amount requested 514 the resources were allocated to the first resource allocation item 302A without an entity having to request those resources (e.g., the resources were allocated using a top-down approach).

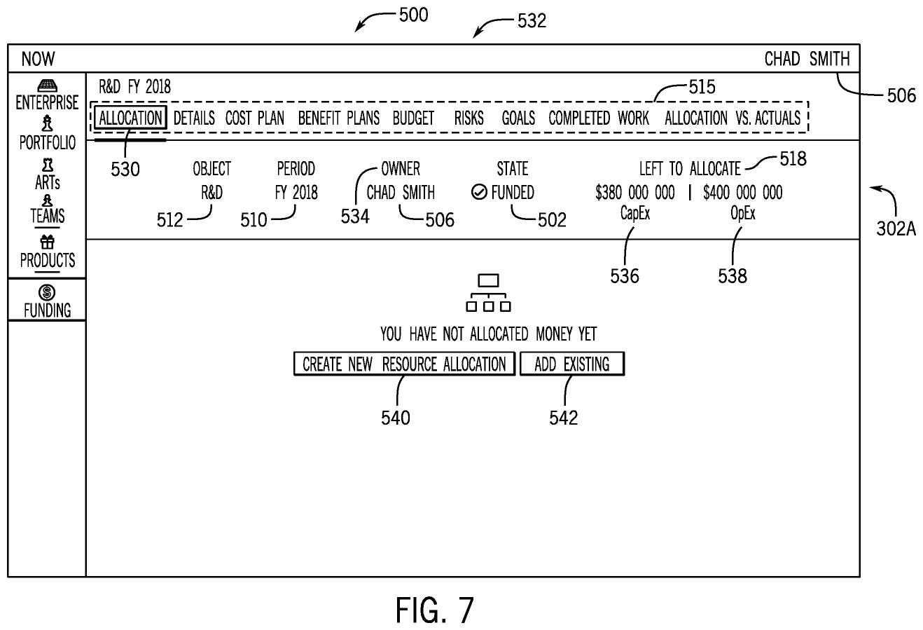

In response to a user selection of the first resource allocation item 302A, the window in FIG. 7 may be presented. To that end, FIG. 7 is an embodiment of an allocation detail view 532 presented on the resource allocation interface 500 for a selected resource allocation item 302 (in this example, the first resource allocation item 302A) from the list of resource allocations of FIG. 6, in accordance with aspects of the present approach. The resource allocation interface 500 may include a navigation panel 515 with a plurality of options that when selected present certain details. For example, in this example, the allocation details option 530 is selected to present allocation detail information about the selected resource allocation item in this example, the first resource allocation item 302A) from the list of resource allocation items of FIG. 6.

The allocation detail view 532 includes the object 512, the period 510, the owner 534 (which, in this example, is the user 506 Chad Smith), the funding state 520, and the amount left to allocate 518. In some contexts, the allocation detail view 532 of the may include the amount left to allocate 518 as the capital expenses 536 (in this example, $380,000,000) and the operational expense amount 538 (in this example, $400,000,000).

As illustrated, the allocation detail view 532 may include a “create new resource allocation” option 540 and a “add existing” option 542. The user 506 may select the “create new resource allocation” option 540 to create a new resource allocation item 302 corresponding to a resource allocation task (e.g., request for resources, allocation of resources, etc.) having information similar to that of the first resource allocation item 302 illustrated in FIG. 7. In addition, the user 506 may select the “add existing” option 542 to add a new resource allocation item 302 modeled after an existing resource allocation item.

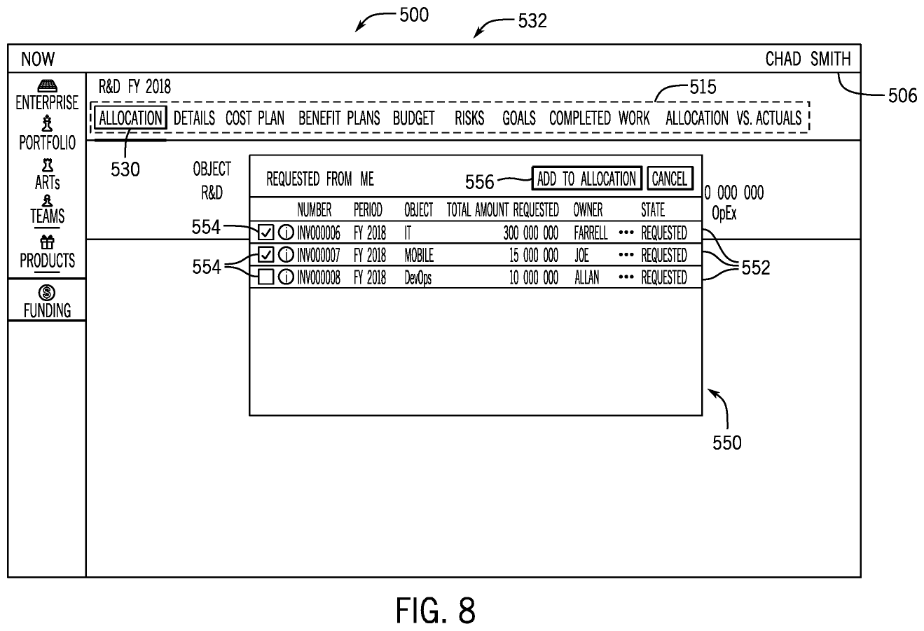

FIG. 8 is an embodiment of a pop-up window 550 for adding new resource allocation items to the list of resource allocation items 302 of FIG. 6, in accordance with aspects of the present approach. To help illustrate, in response to selection of the “create new resource allocation” option 540 of FIG. 7, the computing system may present the pop-up window 550. As illustrated, the pop-up window 550 may include a list of existing resource allocation items 552. In some contexts, the existing resource allocation items 552 may be managed (e.g., owned) by other users. In this example, the pop-up window 550 includes three existing resource allocation items 552, each including a corresponding check box 554. The user 506 may select the checkbox 554 corresponding to the existing resource allocation items 552 and select the “add to allocation” option 556 to cause the computing system (e.g., the computing system 10 of FIG. 1 and/or the computing system 200 of FIG. 3) to add those selected existing resource allocation items 552 to the list of resource allocations 302 of FIG. 6. In this example, the existing resource allocation items 552 having identification numbers “INV00006” and “INV00007” are selected. In this manner, the user 506 may add the existing resource allocation items 552 to the list of resource allocation items 302 of FIG. 6 and/or modify the selected existing resource allocation items 552 (if the user 506 has permissions to do so).

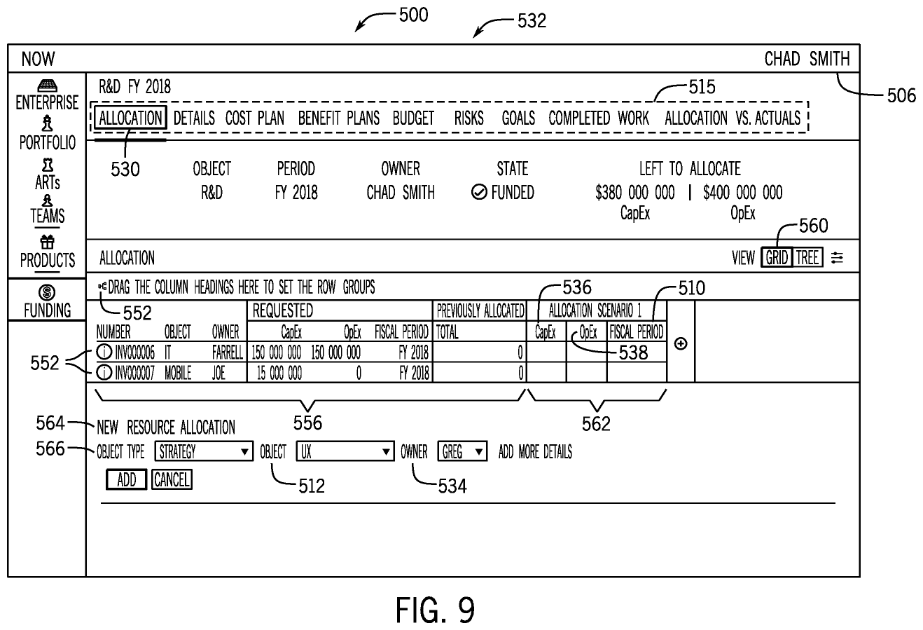

After selecting “add to allocation,” the selected existing resource allocation items 552 may be added to the allocation detail view 532 of the resource allocation interface 500. To this point, FIG. 9 is an embodiment of the allocation detail view 532 of FIG. 7 including the existing resource allocation items 552 added from the pop-up window 550 of FIG. 8, in accordance with aspects of the present approach. In this example, the existing resource allocation items 552 having identification numbers “INV00006” and “INV00007” are presented on the allocation detail view 532 with existing allocation information 556 (e.g., information form FY2018 [i.e., the 2018 fiscal year]). In this example, the existing resource allocation items 552 and their corresponding existing allocation information 556 are presented in a grid view 560.

The existing resource allocation items 552 include a new allocation scenario 562, in which a user 506 may fill in fields designating capital expenses 536, operational expenses 538, the fiscal period 510, and so forth. The user 506 may reference the values in the existing allocation information 556 in designating the new allocation scenario 562 (e.g., to compare the new allocation scenario 562 to the existing allocation information 556).

In addition, the allocation detail view 532 may include an option for creating a new resource allocation item 564, such that a user may designate the object type 566, the object 512, and the owner 534 of the newly created resource allocation items 564. In this manner, the user 506 having the appropriate permissions may create a new resource allocation item 564 in addition to modifying the existing resource allocation items 552.

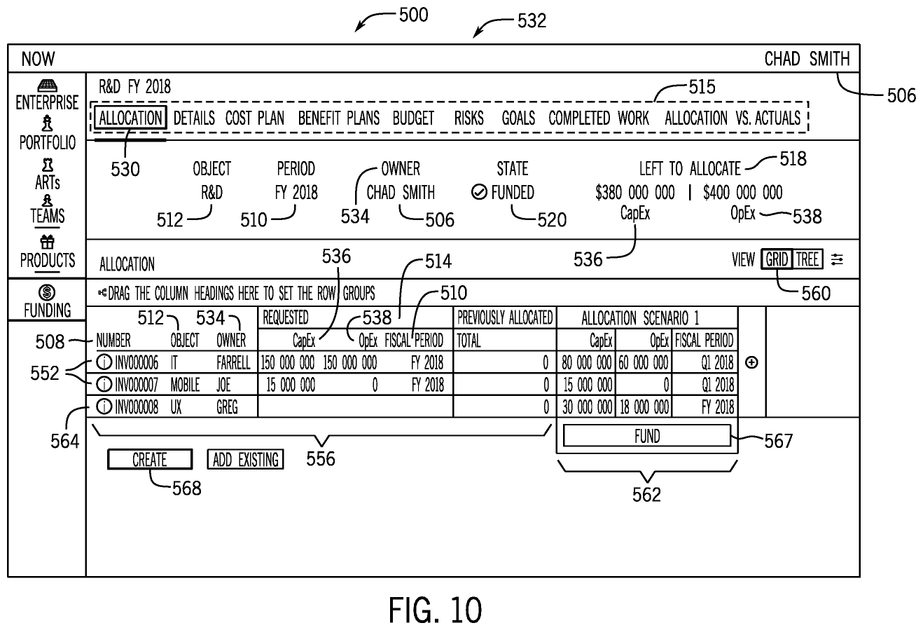

To further illustrate, FIG. 10 is an embodiment of the detail view of FIG. 7 including the existing resource allocation items 552 and the newly created resource allocation item 564, in accordance with aspects of the present approach. In this example, the existing resource allocation items 552 include identification number “INV00006” and “INV00007,” respectively, and the newly created resource allocation item 564 includes identification number “INV00008.” A user 506 with appropriate permissions may fill in the new allocation scenario 562 with desired information and finalize the new allocation scenario 562 by selecting the fund option 567. In addition, in response to a user selection of the “Create Resource Allocation” option 568, the computing system (e.g., the computing system 10 of FIG. 1 and/or the computing system 200 of FIG. 3) may generate the three resource allocation items illustrated in FIG. 10 (i.e., identified with identification numbers “INV00006,” “INV00007,” and “INV00008”).

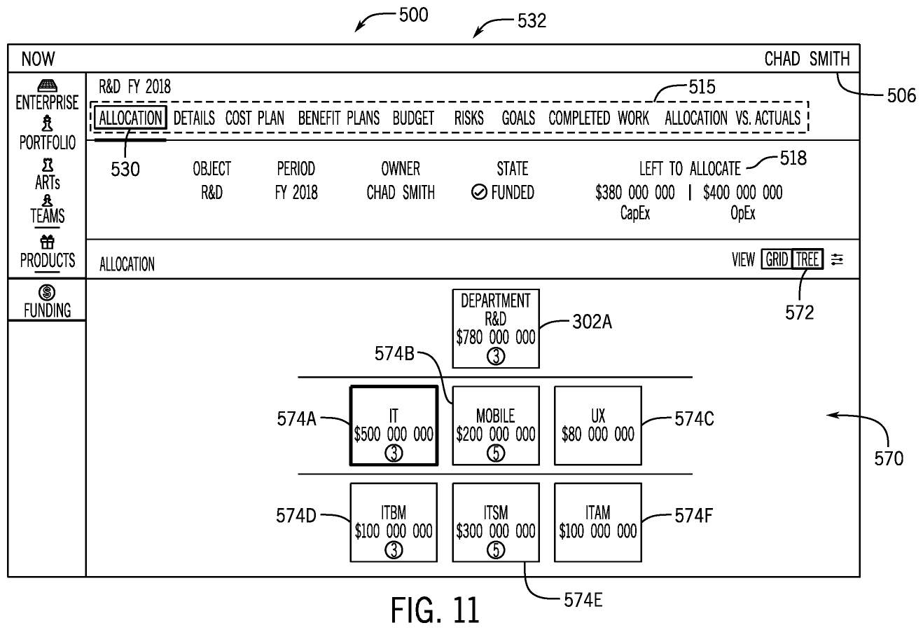

FIG. 11 is a tree representation 570 of the resource allocation items 302A, in accordance with aspects of the present approach. From the allocation detail view 532 of the resource allocation interface 500, the user 506 may select the tree representation option 572 to cause the computing system (e.g., the computing system 10 of FIG. 1 and/or the computing system 200 of FIG. 3) to present the tree representation 570. As illustrated, the amount left to allocate 518 for the first resource allocation item 302A is $780,000,000. In this example, the first resource allocation item 302A includes resources used for three resource sub-allocations 574 (e.g., the first resource sub-allocation items 574A, the second resource sub-allocation items 574B, and the third resource sub-allocation items 574C). In this example, $500,000,000 from the amount left to allocate 518 is designated to the first resource sub-allocation items 574A. In this example, the first resource sub-allocation item 574A is selected, such that the resource sub-allocation items 574 that the first resource sub-allocation items 574A provides resources for are presented. In this example, the first resource sub-allocation items 574A provide resources to a fourth resource sub-allocation item 574D, a fifth resource sub-allocation item 574E, and a sixth resource sub-allocation item 574F. In this manner, a user 506 having permission to access the tree representation 570 of resource allocation items 302A may view (and/or customize) the hierarchy used to fund certain projects and entities within the multi-layer resource allocation hierarchy 400.

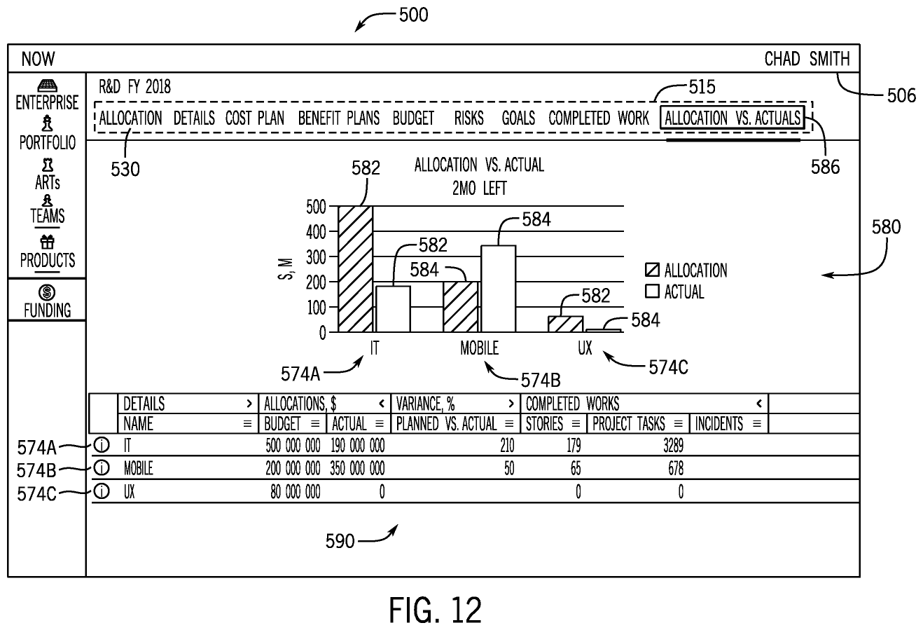

FIG. 12 is an embodiment of a graphical representation 580 of an allocation budget 582 and the actual budget 584 of the resource allocation interface 500 of FIG. 6, in accordance with aspects of the present approach. As illustrated, the user 506 may access the graphical representation 580 by selecting the “allocation vs. actuals” option 586 from the navigation panel 515. That is, in transitioning from the allocation detail view 532 in FIG. 11 to the graphical representation 580 in FIG. 12, the user 506 may select the “allocation vs. actuals” option 586 instead of the “allocation details” option 530 from the navigation panel 515.

In this example, the graphical representation 580 includes a bar graph of the allocation budget 582 and the actual budget 584 for each of the first resource sub-allocation items 574A, the second resource sub-allocation items 574B, and the third resource sub-allocation items 574C. In this manner, a user 506 may view how the allocation budget 582 compares to the actual budget 584. Further, the graphical representation 580 includes an allocation table 590 that includes records that the user 506 may customize in accordance to a desired scheme. For example, the user 506 having permissions to allocate resources may change entries in the illustrated allocation table 590.

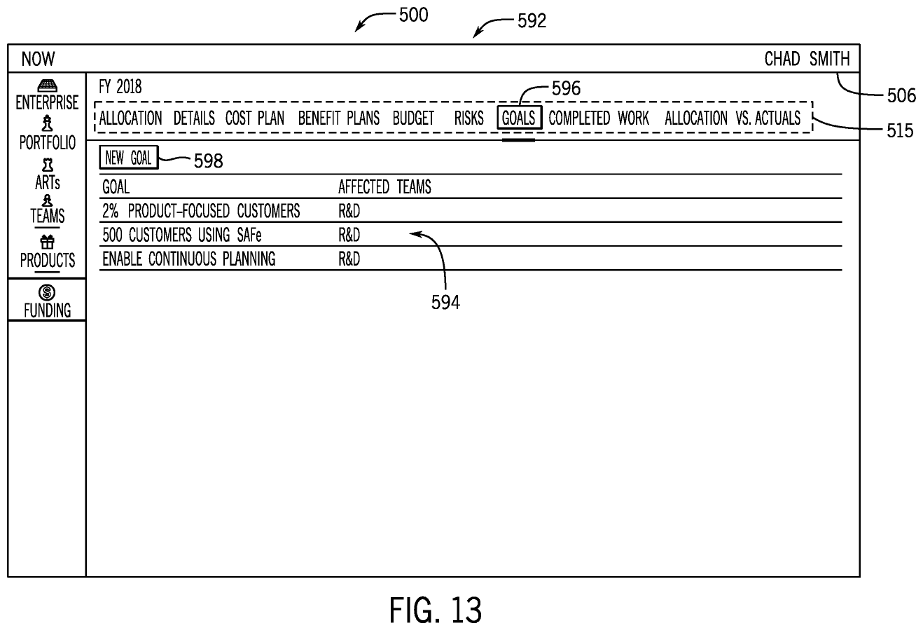

FIG. 13 is an embodiment of a goals detail view 592 of goals 594 associated with a resource allocation item 302, in accordance with aspects of the present approach. As illustrated, the user 506 may access the goals detail view 592 by selecting the “goals” option 596 from the navigation panel 515. That is, in transitioning from the graphical representation 580 in FIG. 12 to the goals detail view 592 in FIG. 13, the user 506 may select the “goals” option 596 from the navigation panel 515. In this manner, the user 506 having permissions may view the goals 594 associated with a resource allocation item 302 or a resource sub-allocation 574.

In addition, from the goals detail view 592, the user 506 may create new goals by selecting the new goals option 598. As may be appreciated, in some contexts, the user 506 may be required have certain permissions allowing the user 506 to create new goals. Indeed, by using the embodiments disclosed herein a user 506 may associate goals to certain resource allocation items in addition to managing the allocation of resources.

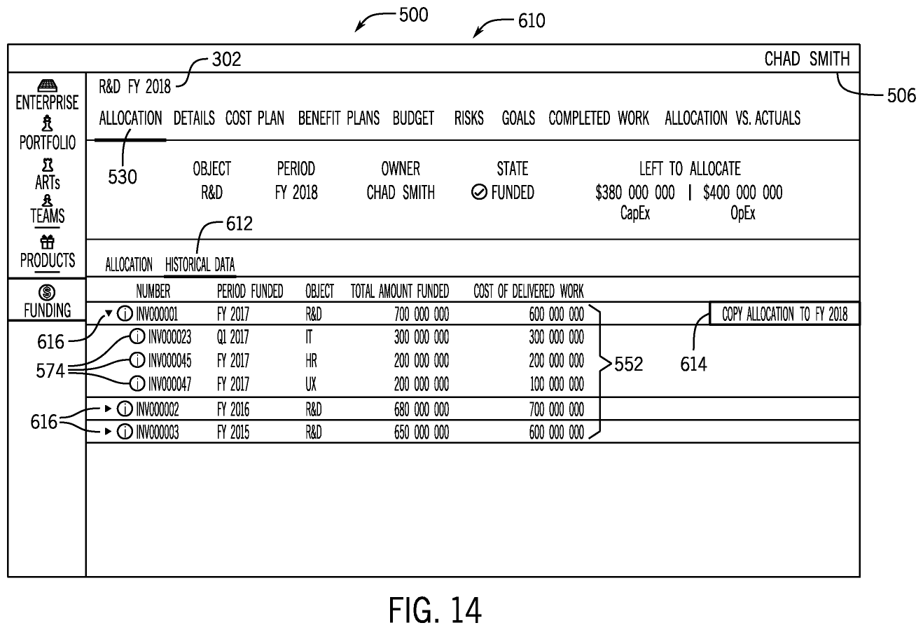

FIG. 14 is an embodiment of a historical data view 610 of historical data 612 associated with a resource allocation item 302, in accordance with aspects of the present approach. In some contexts, the historical data view 610 may be accessed from within the allocation details option 530; namely, by selecting the historical data option 614. The historical data 612 may include previously funded resource allocations 552 associated with a present resource allocation item 302. In this example, the historical data 612 includes information about the corresponding previously funded resource allocation items 616 for the 2017 fiscal year, the 2016 fiscal year, and the 2015 fiscal year. A user 506 may select one of the previously funded resource allocation items 616 to cause the computing system (e.g., the computing system 10 of FIG. 1 and/or the computing system 200 of FIG. 3) to present resource sub-allocations 574 associated with the previously funded resource allocation items 616.

To facilitate generating a new resource allocation modeled after an existing previously funded resource allocations 552, the user 506 may select the “copy” option 614 to copy the previously funded resource allocations 616. In this example, the allocation details view 532 of the resource allocation item 302 “R&D FY 2018” is being viewed. Accordingly, in this example, in response to selection of the “copy” option 614, the previously funded resource allocations 552 having an identification number of “INV000001” is copied.

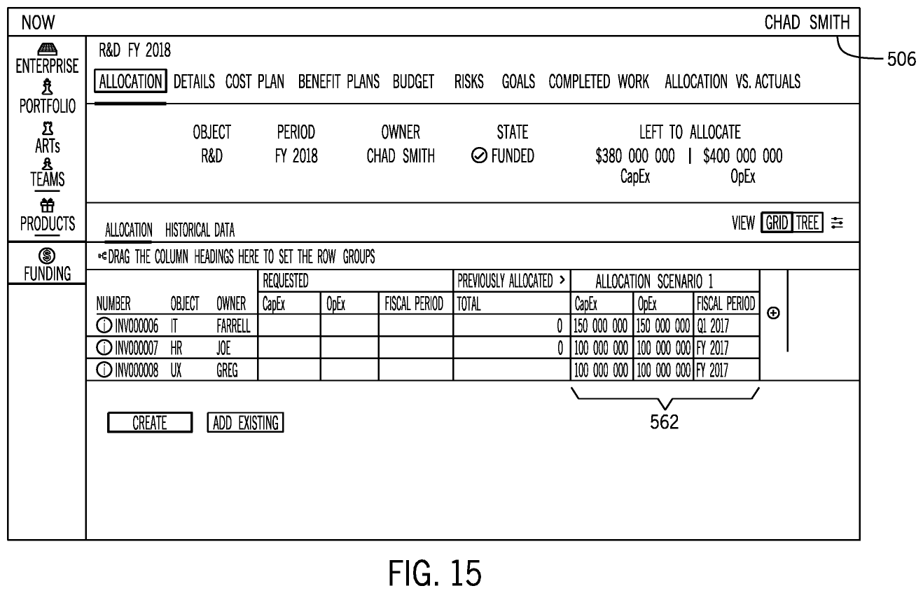

FIG. 15 is an embodiment of using a copy option 614 to propagate fields of a resource allocation item 302 with information copied from a previously funded resource allocations 616, in accordance with aspects of the present approach. After information associated with a previously funded resource allocations 616 has been copied (as shown in FIG. 14), the copied information may be pasted (e.g., via a user command) onto a resource allocation item 302. In the illustrated example, the copied information is pasted to the new allocation scenario 562, such that the entries of the new allocation scenario 562 are propagated.

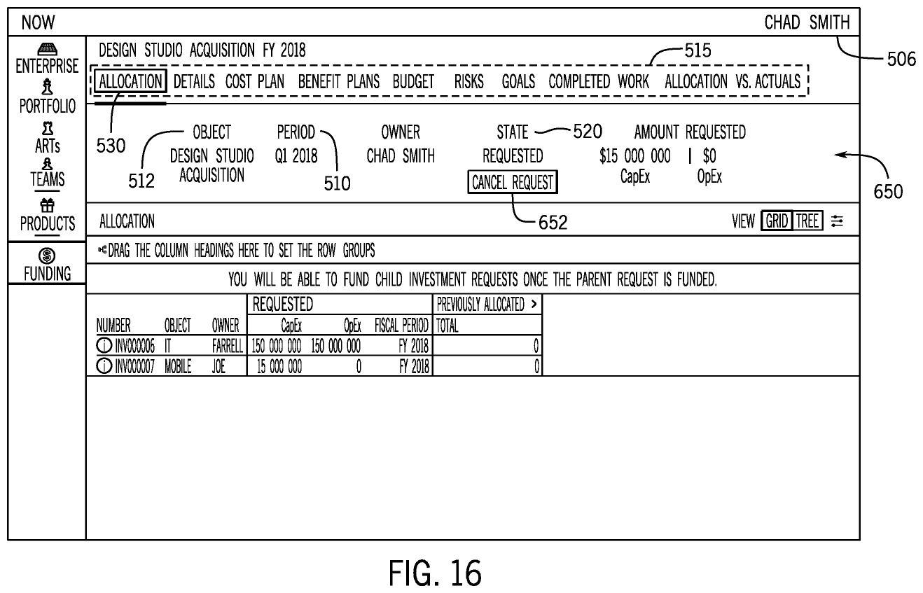

FIG. 16 is an embodiment of allocation detail view of FIG. 7, illustrating a resource allocation item 302 that includes a request 650 for resources, in accordance with aspects of the present approach. In the illustrated example, the user 506 has submitted a request 650 in which the object 512 designated as “Design Studio Acquisition” for the first quarter of the year 2018 in the amount of $15,000,000. The user 506 may cancel the request by selecting the cancel request option 652. In some embodiments, if the request has children requests (i.e., other resource allocation items receiving resources from the request 650), the children requests may be required to get approved before the request 650 is approved by an entity having approval permissions.

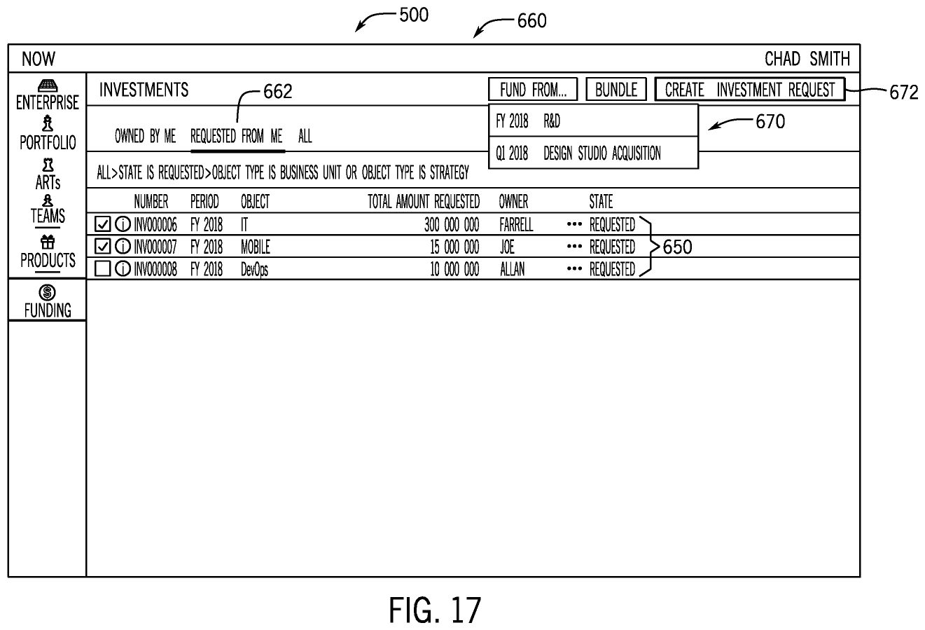

FIG. 17 is an embodiment of a requests view 660 in which the resource allocation interface 500 presents requests 650 for approval, in accordance with aspects of the present approach. In response to selection of the “requested from me” option 662, the computing system (e.g., the computing system 10 of FIG. 1 and/or the computing system 200 of FIG. 3) may show the resource allocation items 302 that include requests 650. In some contexts, only users 506 having permissions for approving or allocating resources (e.g., as determined by the computing system) may receive requests 650 and approve the requests 650. The resource allocation interface 500 includes fund sources 670 from which the requests 650 may be funded from. In this example, the request having an identification number “INV000006” may be funded from the FY 2018 budget or from the Q1 2018 budget from the list of fund sources 670. Based on the permissions associated with the user 506, the user may also create a request 650 by selecting the create request option 672.

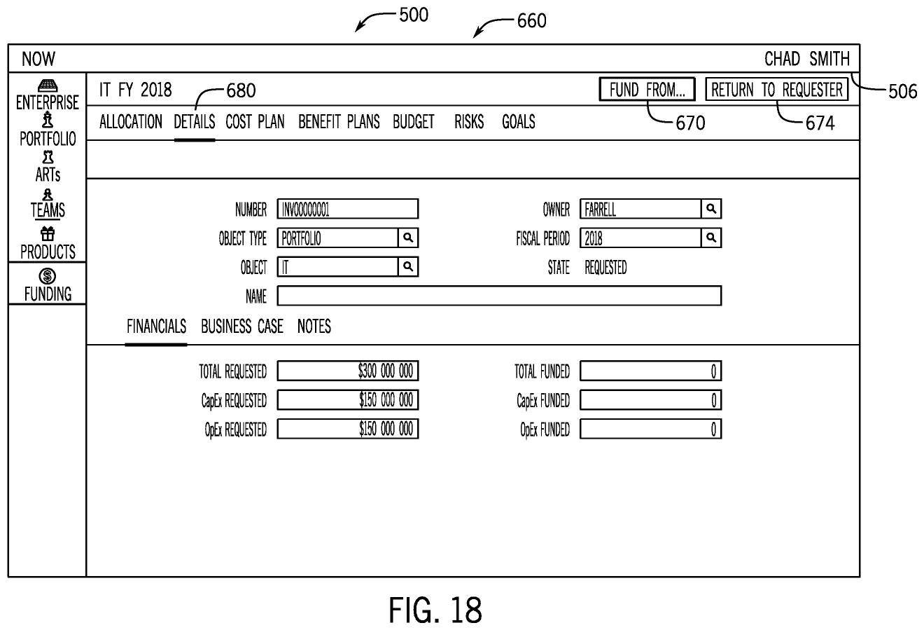

FIG. 18 is an additional embodiment of a requests view 660 in which the resource allocation interface 500 presents requests 650 for approval, in accordance with aspects of the present approach. In response to selection of one of the requests 650 from the lists of requests 650 from FIG. 17, the computing system (e.g., the computing system 10 of FIG. 1 and/or the computing system 200 of FIG. 3) may show the illustrated request view 660. As illustrated, the request view 660 includes detail information 680 about the selected request 650. For example, the request view 660 may include detail information 680, such as the identification number, the object type, the object, the name, the owner, the fiscal period, the funding state, the total amount request (e.g., shown as the capital expense requested and the operational expense requested), and the total amount funded (e.g., shown as the capital expense funded and the operational expense funded).

As mentioned above, in some contexts, only users 506 having permissions for approving or allocating resources (e.g., as determined by the computing system) may receive requests 650 and approve the requests 650. The resource allocation interface 500 includes fund sources 670 from which the requests 650 may be funded. In addition, the resource allocation interface 500 may include a “return to requestor” option 674, whereby the request 650 is rejected by the user 506. Based on the permissions associated with the user 506, the user may also create a request 650 by selecting the create request option 672.

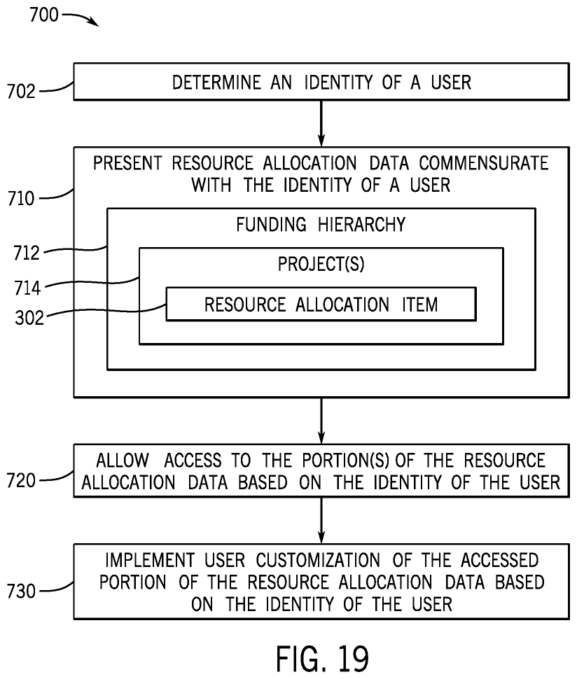

FIG. 19 is a flow diagram of an embodiment of a process 700 for facilitating the management of resource allocations, in accordance with aspects of the present approach. In some contexts, the steps of the process flow diagram 350 may be stored as code in one or more non-transitory mediums (e.g., memories of a data server storing instructions and/or the memory 206 of FIG. 3). The instructions may be executed by one or more hardware processors (e.g., of an application server and/or the one or more processors 202 of FIG. 3), such that the one or more hardware processors may execute the code to perform the process flow diagram 350.

As illustrated, the process includes determining (process block 702) an identity of a user. For example, each user may include an identifier that designates the role of the user within the enterprise and that designates the layer within the multi-layer hierarchy of the user. As such, determining (process block 702) the identity of the user may include determining a group which the user is a part of (e.g., determining which layer in the multi-layer hierarchy 400 the user is a part of) and determining the individual identity of the user. To that end, in some contexts, the process includes determining permissions associated with the user based on group permissions associated with the layer the user is assigned to and based on individual permissions delegated to the user. In some contexts, a user with a higher role (e.g., CIO) may include permissions higher than the permissions of the lower roles (e.g., project manager). Higher role may refer to a role higher on the multi-layer hierarchy 400 and having responsibility over the allocation of more funds than the lower roles.

The process also includes presenting (process block 710) resource allocation data commensurate with the identity of the user. That is, the resource allocation data presented to the user may be based on the group permissions, the individual permissions, or both associated with a user. In this manner, certain resource allocation data may be hidden to users who lack certain permissions (as determined based on the identity of the user). Similarly, certain resource allocation data may be available to users having certain permissions (as determined based on the identity of the user).

For example, the process 700 may include presenting users with a funding hierarchy 712 that includes the arrangement of resource allocation items showing the flow of resources between resource allocation items 302 in response to determining that the identity of the user satisfies a criteria for granting permissible access to the funding hierarchy 712. In another example, the process 700 may include presenting users with resource allocation data indicative of resource allocation projects 714. The resource allocation projects 714 may include one or more related resource allocation items 302 commensurate with an identity of the user (e.g., such that the identity of the user satisfies a criteria for granting permissible access to the projects 714). In yet another example, the process 700 may include presenting users with resource allocation data indicative of a resource allocation items 302 in response to determining that the identity of the user satisfies a criteria for granting permissible access to the resource allocation item 302. In certain embodiments, the user may include permissions to access the funding hierarchy 712, the projects 714, the resource allocation item 302, or any other resource allocation data, or any combination thereof.

The process further includes allowing (process block 720) the user to access portions of the resource allocation data commensurate with their identity to perform permissible functionality of the portions of the resource allocation data. For example, as set forth above, the functions that a user may perform include requesting resource allocations, approving requested resource allocations, creating new resource allocations, viewing existing resource allocation requests and existing resource allocations, copying existing resource allocations to create new resource allocations, just to name a few. It should be understood that the permissible functions that a user may perform based on their identity may include any action associated with managing the allocation of resources within the enterprise.

In response to receiving user modifications based on the permissible functions and actions the user may undertake, the process also includes implementing (process block 730) and incorporating the user modifications/actions. In this manner, the user may create a new resource allocation item, request funds for a resource allocation item, allocate funds for resource allocation item, approve requests for funds, and customize existing resource allocation item, to name a few resource allocation functionalities.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Technical effects of the present disclosure include enhancing the organization and overall management of resource allocation items by way of a resource allocation interface implemented by a computing system. The present disclosure includes a system that determines an identity of an entity within an overall multi-layer resource allocation hierarchy. The computing system may then present resource allocation data on the disclosed resource allocation interface commensurate with the identity of the user or the layer of the hierarchy with which the user is associated. The computing system may allow user access to the portions of the resource allocation data based on the identity of the user or the layer of the hierarchy with which the user is associated. In response to receiving user inputs to the portions of the resource allocation data the user has permission to access, the computing system implements the user customizations based on those user inputs. In this manner, the user may create a new project, request funds for a project, allocate funds, approve requests for funds, customize existing resource allocation plans, and so forth.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A resource allocation system for managing allocation of resources within one unified user interface, the resource allocation system comprising:
a memory device; and
one or more hardware processors configured to read instructions from the memory device and execute the instructions to perform operations comprising:
determining an identity of a user and a position of the user within a multi-layer resource allocation hierarchy of authority within an enterprise;
determining one or more permissible resource allocation functions for the user based on the identity of the user and the position of the user;
presenting resource allocation data on the one unified user interface from multiple sources, wherein the resource allocation data is specified as being accessible to a user having the determined identity and position; and
receiving one or more inputs from the user to perform the one or more permissible resource allocation functions for the presented resource allocation data based on the identity of the user and the position of the user.

2. The resource allocation system of claim 1, wherein the operations comprise modifying the resource allocation data in response to the user performing at least one of the one or more permissible resource allocation functions.

3. The resource allocation system of claim 1, wherein the one or more permissible resource allocation functions comprise requesting resource allocations, approving requested resource allocations, creating new resource allocations, or viewing existing resource allocation requests and existing resource allocations, or any combination thereof.

4. The resource allocation system of claim 1, wherein the position of the user within the multi-layer resource allocation hierarchy of authority comprises a level of authority of the user relative to other users in the enterprise.

5. The resource allocation system of claim 1, wherein the position specifies whether the user is a member of a certain project, whether the user is a portfolio manager responsible for a plurality of projects, or whether the user is an executive within the enterprise, or any combination thereof.

6. The resource allocation system of claim 1, wherein the resource allocation data comprises information indicative of resource allocations within the enterprise, the information comprising a hierarchy of resource allocation items showing a flow of resources between the resource allocation items in the hierarchy, a project comprising one or more related resource allocation items, a single resource allocation item, or any combination thereof.

7. The resource allocation system of claim 1, wherein determining the position of the user comprises determining the role of the user relative to the role of other users in the enterprise, wherein the one or more permissible resource allocation functions of the user are based on the role of the user relative to other users in the enterprise.

8. The resource allocation system of claim 7, wherein presenting the resource allocation data comprises omitting a portion of the resource allocation data for which the identity of the user and the position of the user lack permission to access.

9. The resource allocation system of claim 8, wherein the omitted portion of the resource allocation data comprises functionality associated with granting and approving of resource allocation requests.

10. The resource allocation system of claim 1, wherein the operations comprise synchronizing various aspects of the management of the allocation of resources.

11. The resource allocation system of claim 10, wherein the various aspects of the management of the allocation of resources comprise:
a first selectable option for requesting resources;
a second selectable option for creating a new resource allocation item;
a third selectable option for copying an existing allocation item to create the new resource allocation item;
a fourth option for approving requests for resources; or
a fifth option for viewing certain resource allocation items; or
any combination thereof.

12. A method for providing access to resource allocation data for users of a software resource within one unified user interface, the method comprising:
assigning a user to a layer of a multi-layer resource allocation hierarchy indicative of organization within an enterprise;
assigning the user an individual permission associated with an identity of the user and a group permission associated with the layer of the multi-layer resource allocation hierarchy to which the user is assigned;
presenting resource allocation data on the one unified user interface from multiple sources, wherein the resource allocation data is specified as being accessible to a user having the individual permission and the group permission; and
receiving one or more inputs from the user to perform one or more permissible resource allocation functions for the presented resource allocation data based on the individual permission and on the group permission.

13. The method of claim 12, comprising modifying the resource allocation data in response to the user performing at least one of the one or more permissible resource allocation functions.

14. The method of claim 12, wherein the one or more permissible resource allocation functions comprise requesting resource allocations, approving requested resource allocations, creating new resource allocations, or viewing existing resource allocation requests and existing resource allocations, or any combination thereof.

15. The method of claim 12, wherein assigning the user the individual permission and the group permission is based on a role of the user relative to a role of other users in the enterprise, wherein the one or more permissible resource allocation functions of the user are based on the role of the user relative to other users in the enterprise.

16. A non-transitory computer readable medium comprising computer readable code, that when executed by one or more processors, causes the one or more processors to perform operations comprising:
assigning a user to a layer of a multi-layer resource allocation hierarchy indicative of organization within an enterprise;
assigning the user an individual permission associated with an identity of the user and a group permission associated with the layer of the multi-layer resource allocation hierarchy to which the user is assigned;
presenting resource allocation data on the one unified user interface from multiple sources, wherein the resource allocation data is specified as being accessible to a user having the individual permission and on the group permission; and
receiving one or more inputs from the user to perform one or more permissible resource allocation functions for the presented resource allocation data based on the individual permission and on the group permission.

17. The non-transitory computer readable medium of claim 16, wherein the operations comprise modifying the resource allocation data in response to the user performing at least one of the one or more permissible resource allocation functions.

18. The non-transitory computer readable medium of claim 16, wherein the one or more permissible resource allocation functions comprise requesting resource allocations, approving requested resource allocations, creating new resource allocations, or viewing existing resource allocation requests and existing resource allocations, or any combination thereof.

19. The non-transitory computer readable medium of claim 16, wherein the operations comprise synchronizing various aspects of the management of the allocation of resources.

20. The non-transitory computer readable medium of claim 16, wherein the various aspects of the management of the allocation of resources comprise:
a first selectable option for requesting resources;
a second selectable option for creating a new resource allocation item;
a third selectable option for copying an existing allocation item to create the new resource allocation item;
a fourth option for approving requests for resources; or
a fifth option for viewing certain resource allocation items; or
any combination thereof.
